(19) United States
(12) Patent Application Publication
(10) Pub. No.: US 2025/0305586 A1
(43) Pub. Date: Oct. 2, 2025

(54) SYSTEM AND METHOD FOR VALVE ASSEMBLY

(71) Applicant: Vulcan Industrial Holdings, LLC, Houston, TX (US)

(72) Inventors: Chance Ray Mullins, Spring, TX (US); Jason David Smith, Porter, TX (US); Steven Zachary Newberg, Houston, TX (US)

(73) Assignee: Vulcan Industrial Holdings, LLC, Houston, TX (US)

(21) Appl. No.: 19/184,468

(22) Filed: Apr. 21, 2025

Related U.S. Application Data
(63) Continuation of application No. 17/678,136, filed on Feb. 23, 2022, now Pat. No. 12,292,120.
(60) Provisional application No. 63/152,501, filed on Feb. 23, 2021.

(51) Int. Cl. F16K 1/36; F04B 53/10; F04B 53/12; F16K 1/48

(52) U.S. Cl. CPC F16K 1/36; F04B 53/1027; F04B 53/127; F16K 1/48

(57) ABSTRACT

A valve assembly includes an upper portion to be coupled to guide legs, a cavity being formed within one of the upper portion or the guide legs and a coupling member being associated with the other of the upper portion or the guide legs, wherein the upper portion is coupled to the guide legs via a single force application process.

### CROSS REFERENCE TO RELATED APPLICATIONS

This application is a continuation of U.S. Non-Provisional application Ser. No. 17/678,136, filed Feb. 23, 2022, titled “SYSTEM AND METHOD FOR VALVE ASSEMBLY,” now U.S. Pat. No. 12,292,120, issued May 6, 2025, which claims the benefit of U.S. Provisional Patent Application No. 63/152,501, filed Feb. 23, 2021, titled “SYSTEM AND METHOD FOR VALVE ASSEMBLY,” the full disclosures of which are hereby incorporated herein in their entireties by reference.

### TECHNICAL FIELD

Embodiments of the subject matter disclosed herein generally relate to pump systems, and in particular to valves in pump systems.

### BACKGROUND

Pumping systems may be used in a variety of applications, especially industrial applications where pumping systems are used to elevate a working fluid pressure. One such application is hydraulic fracturing systems, where high pressure pumps are used to increase a fluid pressure of a working fluid (e.g., fracturing fluid, slurry, etc.) for injection into an underground formation. The working fluid may include particulates, which are injected into fissures of the formation. When the fluid is removed from the formation, the particulates remain and “prop” open the fissures, facilitating flow of oil and gas. In many applications, reciprocating pumps are used where a fluid is introduced into a fluid end inlet passage and out through an outlet passage. A valve assembly includes valve members that reciprocate and contact valve seats at the inlet and outlet passages. Due to the particulates and corrosive nature of the working fluid, the valve seats and/or portions of the valve member may become eroded or otherwise damaged, which my prevent sealing of the inlet and outlet passages.

### SUMMARY

Applicant recognized the problems noted above herein and conceived and developed embodiments of systems and methods, according to the present disclosure, for valve assemblies.

In an embodiment, a valve member includes an upper portion, guide legs, and a sealing element. The upper portion includes a top side, an underside, an annular recess positioned between the top side and the underside, and a cavity extending at least partially into a body of the upper body, the cavity arranged at the underside. The guide legs include a plurality of legs and a coupling member extending axially from the plurality of legs. The sealing element is configured to be installed within the annular recess. The upper portion is coupled to both the guide legs and the sealing element via a single force application process to axially position the sealing element within the annular recess and to position the coupling member into the cavity.

In an embodiment, a valve member includes an upper portion, guide legs, and a sealing element. The upper portion includes a top side, an underside, an annular recess positioned between the top side and the underside, and a cavity extending at least partially into a body of the upper body, the cavity arranged at the underside. The guide legs include a plurality of legs and a coupling member extending axially from the plurality of legs. The sealing element is configured to be installed within the annular recess. The upper portion is coupled to at least one of the guide legs or the sealing element via a single force application process.

In another embodiment, a method for forming a valve member includes positioning guide legs within a fixture. The method also includes positioning, axially away from the guide legs, a sealing element. The method further includes positioning, axially higher than the sealing element, a carrier portion. The method also includes applying a linear force to drive each of the guide legs, the sealing element, and the carrier portion into a mating relationship.

In an embodiment, a valve assembly includes an upper portion to be coupled to guide legs, a cavity being formed within one of the upper portion or the guide legs and a coupling member being associated with the other of the upper portion or the guide legs, wherein the upper portion is coupled to the guide legs via a single force application process.

### BRIEF DESCRIPTION OF THE DRAWINGS

The present technology will be better understood on reading the following detailed description of non-limiting embodiments thereof, and on examining the accompanying drawings, in which:

FIG. 1 is a schematic cross-sectional view of an embodiment of a pump assembly, in accordance with embodiments of the present disclosure;

FIG. 2 is a schematic sectional view of an embodiment of a valve assembly, in accordance with embodiments of the present disclosure;

FIG. 3A is an exploded sectional view of an embodiment of a valve member, in accordance with embodiments of the present disclosure;

FIG. 3B is an exploded perspective view of an embodiment of a valve member, in accordance with embodiments of the present disclosure;

FIG. 3C is a top perspective view of an embodiment of a valve member, in accordance with embodiments of the present disclosure;

FIG. 3D is a cross sectional view of an embodiment of a valve member, in accordance with embodiments of the present disclosure;

FIG. 4A is an exploded sectional view of an embodiment of a valve member, in accordance with embodiments of the present disclosure;

FIG. 4B is an exploded perspective view of an embodiment of a valve member, in accordance with embodiments of the present disclosure;

FIG. 4C is a top perspective view of an embodiment of a valve member, in accordance with embodiments of the present disclosure;

FIG. 4D is a sectional view of an embodiment of a valve member, in accordance with embodiments of the present disclosure;

FIG. 4E is a cross sectional view of an embodiment of a valve member, in accordance with embodiments of the present disclosure;

FIG. 5A is an exploded sectional view of an embodiment of a valve member, in accordance with embodiments of the present disclosure;

FIG. 5B is an exploded perspective view of an embodiment of a valve member, in accordance with embodiments of the present disclosure;

FIG. 5C is a top perspective view of an embodiment of a valve member, in accordance with embodiments of the present disclosure;

FIG. 5D is a cross sectional view of an embodiment of a valve member, in accordance with embodiments of the present disclosure;

FIG. 5E is a sectional view of an embodiment of a valve member, in accordance with embodiments of the present disclosure;

FIG. 6 is a schematic diagram of an embodiment of a method for forming a valve member, in accordance with embodiments of the present disclosure;

FIG. 7 is a schematic diagram of an embodiment of a method for forming a valve member, in accordance with embodiments of the present disclosure;

FIG. 8A is an exploded sectional view of an embodiment of a valve member, in accordance with embodiments of the present disclosure;

FIG. 8B is an exploded perspective view of an embodiment of a valve member, in accordance with embodiments of the present disclosure;

FIG. 8C is a top perspective view of an embodiment of a valve member, in accordance with embodiments of the present disclosure;

FIG. 8D is a cross sectional view of an embodiment of a valve member, in accordance with embodiments of the present disclosure;

FIG. 9A is an exploded sectional view of an embodiment of a valve member, in accordance with embodiments of the present disclosure;

FIG. 9B is an exploded perspective view of an embodiment of a valve member, in accordance with embodiments of the present disclosure;

FIG. 9C is a top perspective view of an embodiment of a valve member, in accordance with embodiments of the present disclosure;

FIG. 9D is a side view of an embodiment of a valve member, in accordance with embodiments of the present disclosure;

FIG. 9E is a cross sectional view of an embodiment of a valve member, in accordance with embodiments of the present disclosure; and

FIG. 9F is a cross sectional view of an embodiment of a valve member, in accordance with embodiments of the present disclosure.

### DETAILED DESCRIPTION

The foregoing aspects, features, and advantages of the present disclosure will be further appreciated when considered with reference to the following description of embodiments and accompanying drawings. In describing the embodiments of the disclosure illustrated in the appended drawings, specific terminology will be used for the sake of clarity. However, the disclosure is not intended to be limited to the specific terms used, and it is to be understood that each specific term includes equivalents that operate in a similar manner to accomplish a similar purpose.

When introducing elements of various embodiments of the present disclosure, the articles “a”, “an”, “the”, and “said” are intended to mean that there are one or more of the elements. The terms “comprising”, “including”, and “having” are intended to be inclusive and mean that there may be additional elements other than the listed elements. Any examples of operating parameters and/or environmental conditions are not exclusive of other parameters/conditions of the disclosed embodiments. Additionally, it should be understood that references to “one embodiment”, “an embodiment”, “certain embodiments”, or “other embodiments” of the present disclosure are not intended to be interpreted as excluding the existence of additional embodiments that also incorporate the recited features. Furthermore, reference to terms such as “above”, “below”, “upper”, “lower”, “side”, “front”, “back”, or other terms regarding orientation or direction are made with reference to the illustrated embodiments and are not intended to be limiting or exclude other orientations or directions.

Embodiments of the present disclosure are directed toward systems and methods for forming components of a valve assembly. In various embodiments, the systems and methods described herein are directed toward a valve traditionally formed from a metal body with an elastomer sealing element and introduces a metal body with at least two pieces where the sealing element and the guide legs may be made from separate materials and/or using separate methods and then assembled together during the process of installing the non-metallic sealing element.

In various embodiments, a method may be directed toward placing the guide legs into a fixture, placing the non-metallic sealing element into the same fixture axially distanced from the guide legs, placing the metal sealing element/non-metallic seal carrier into the top of the fixture, and applying a linear force driving the three components together in a single operation.

In various embodiments, a method may be directed toward placing the guide legs into a fixture, placing the metal sealing element/non-metallic seal carrier into the top of the fixture, applying a linear force driving the two components together, placing the non-metallic element into a fixture, placing the assembled seal carrier/guide legs into a fixture, and applying a linear force driving the non-metallic seal onto the resident seal carrying ring.

Various embodiments of the present disclosure are directed toward two or more unique pieces that are pressed together via a linear force to make up the seal carrying element and the guide legs. The guide legs can be made from metallic or composite elements. The entire assembly is then press fit together either in a single operation or two separate operations. Various embodiments are directed toward a first body piece having a cavity that receives at least a portion of the guide legs. The guide legs may be press fit into the cavity and maintained in position via an interference fit between the cavity and the guide legs. Furthermore, in one or more embodiments, the guide legs may include snaps or fingers that may be biased inwardly when inserted into the cavity and then extend radially outward to secure the fingers to a ledge or shelf formed in the cavity. Furthermore, in one or more embodiments, a snap ring, o-ring, or the like may be utilized with the cavity and/or guide legs.

In at least one embodiment, guide legs are secured to the seal carrier using one or more operations, such as a press fit, threads, external fasteners, or the like, and a seal element is press fit onto the seal carrier.

Traditional valves are formed using a two-piece metal body where the guide legs are threaded into a top element. The non-metallic seal element is molded onto the top element. Furthermore, other prior art valves may feature two different cast-in-place sealing materials for use with the valves and may further include retention features for the sealing element.

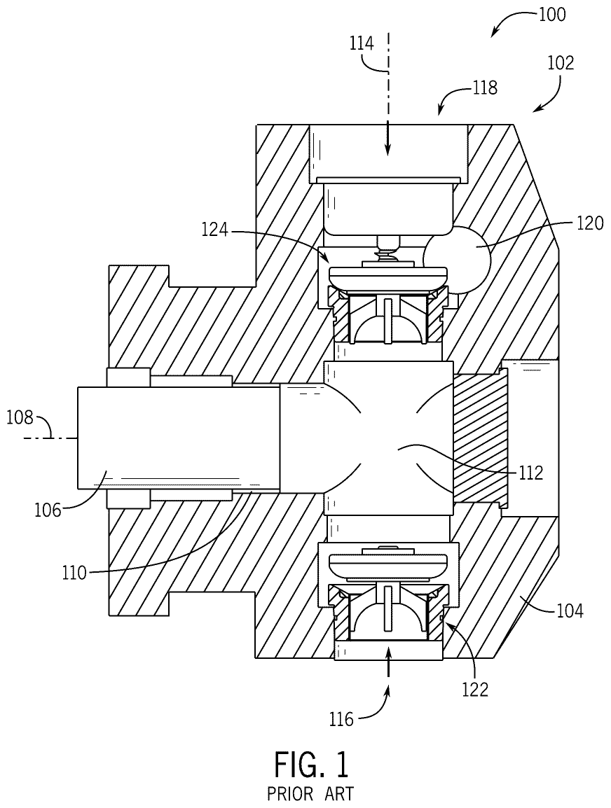

FIG. 1 is a schematic cross-sectional view of an embodiment of a pump assembly 100, which may also be referred to as a reciprocating pump assembly and/or a reciprocating pump.

The pump assembly 100 may be utilized during hydraulic fracturing operations, among other operations, where a working fluid (e.g., fracturing fluid, slurry, etc.) is introduced into the pump and energy is added to the working fluid to increase a pressure of the working fluid. Fracturing fluid, by way of example only, may include corrosives and also particulates, such as sand or ceramics, which are utilized during fracturing operations. These corrosives and particulates cause erosion within the pump assembly 100, which may undesirably affect fracturing operations and lead to down times to replace various components. Additionally, the fracturing fluids may include corrosive acids and the like, which may wear down components of the pump assembly 100.

It should be appreciated that various components of the pump assembly 100 have been removed for clarity with the following discussion. For example, a power end has been removed in favor of focusing on the illustrated fluid end 102 of the pump assembly 100. The power end may include a crankshaft that is driven by an engine or motor to facilitate operations. The fluid 102 includes a fluid end block 104 that may house one or more components discussed herein. A plunger rod 106 is driven (e.g., via the crankshaft) to reciprocate within the fluid end block 104 along a plunger axis 108. The plunger rod 106 is positioned within a bore 110 extending through at least a portion of the fluid end block 104. The illustrated bore 110 is arranged along the plunger axis 108 (e.g., first axis) and intersects a pressure chamber 112, which is arranged along a pressure chamber axis 114 (e.g., second axis), which is positioned substantially perpendicular to the plunger axis 108. It should be appreciated that the pump assembly 100 may include multiple plunger rod and pressure chamber arrangements, which may be referred to as a plunger throw. For example, the pump assembly 100 may be a triplex pump, quadplex pump, quintuplex pump, and the like.

The illustrated fluid end block 104 includes an inlet passage 116 and an outlet chamber 118, which are generally coaxial and arranged along the pressure chamber axis 114. In other words, the inlet passage 116 and the outlet chamber 118 are axially aligned with respect to one another and/or the pressure chamber 112. In various embodiments, fluid enters the pressure chamber 112 via the inlet passage 116, for example on an up stroke of the plunger 106, and is driven out of the pressure chamber 112 into the outlet chamber 118 and out an outlet passage 120, for example on a down stroke of the plunger 106.

Respective valve assemblies 122, 124 are arranged within the inlet passage 116 and the outlet chamber 118. These valve assemblies 122, 124 are spring loaded in the illustrated embodiment, but it should be appreciated that such an arrangement is for illustrative purposes only. In operation, a differential pressure may drive movement of the valve assemblies. For example, as the plunger rod 106 is on the upstroke, pressure at the inlet passage 116 may overcome the spring force of the valve assembly 122, thereby driving fluid into the pressure chamber 112. However, on the down stroke, the valve assembly 122 may be driven to a closed position, while the spring force of the valve assembly 124 is overcome, thereby enabling the fluid to exit via the outlet passage 120.

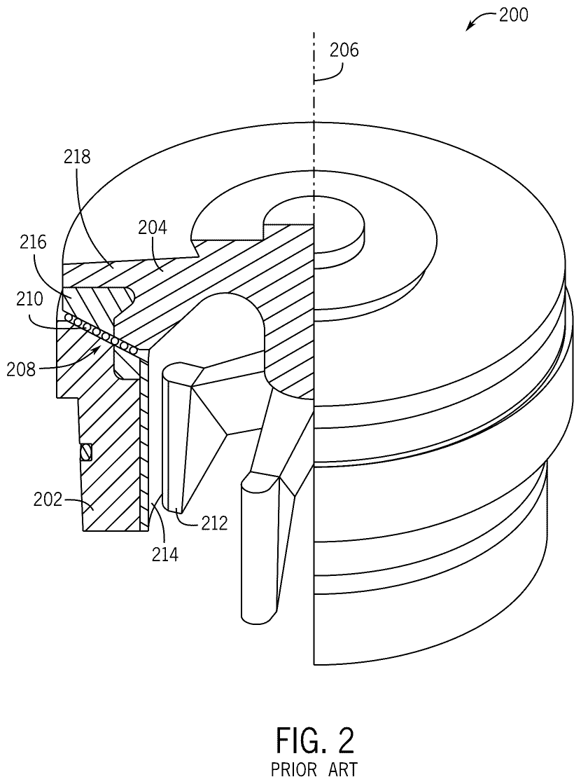

FIG. 2 is a schematic cut away view of an embodiment of a valve assembly 200, such as the valve assemblies 122, 124, which may be utilized with a pump assembly. The illustrated valve assembly 200 includes a valve seat 202 and a valve member 204. In operation, the valve member 204 reciprocates along a valve axis 206, which may correspond to the pressure chamber axis 114, such that the valve member 204 moves into and out of contact with the valve seat 202. In the illustrated embodiment, particulates 208 have accumulated along the valve seat 202, for example at a strike face 210 (e.g., contact face). Repeated contact from the valve member 204 may drive the particulates 208 into the strike face 210, causing scarring or other damage to one or both of the valve seal 216 and/or valve member 204. Additionally, corrosive fluids may contact other portions of the valve seat 202 and/or valve member 204, in addition to the strike face 210. Damage to the valve seat 202 and/or valve member 204 may cause the sealing capability of the valve assembly 200 to degrade, thereby reducing the effectiveness of the pump assembly.

In various embodiments, guide legs 212 of the valve member 204 may also lead to damage to various portions of the valve seat 202. For example, in the illustrated embodiment, the guide legs 212 extend along a bore 214 of the valve member 204. Due to the presence of the corrosive fluid and/or the particulates, damage may occur along the bore 214, such as scarring. Additionally, damage may also accumulate on the guide legs 212. As a result, the pump assembly may be taken out of service for repairs, which may be expensive and also contribute to non-productive time at the well site. Furthermore, various components of the valve assembly 200 are often replaced rather than repaired, thereby increasing costs for operators.

While various components of the valve seat 202 may be exposed to damage, similar damage may also occur to the valve member 204. For example, the valve member 204 may include a sealing element 216 (e.g., sealing assembly, seal assembly) arranged circumferentially about a body 218 (e.g., valve body). In various embodiments, the sealing element 216 is an elastomer, which may be susceptible to damage due to repeated contact with the particulates 208 and/or due to the force of striking the strike face 210. Damage to the valve member 204 may also reduce the sealing effectiveness of the valve assembly 200, thereby leading to replacement or repairs. During a typical fracturing operation, hundreds of valve members 204 may be replaced, which can lead to high costs for operators. Embodiments of the present disclosure may include systems and methods directed toward the valve member 204.

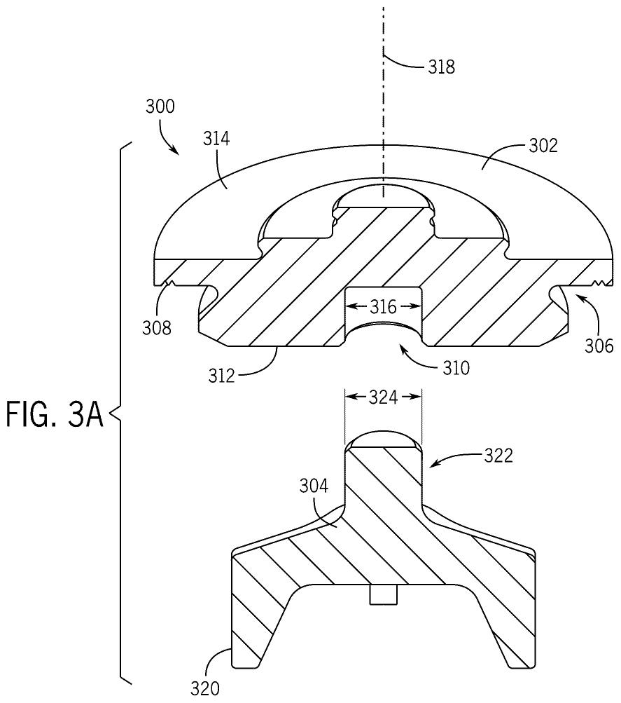

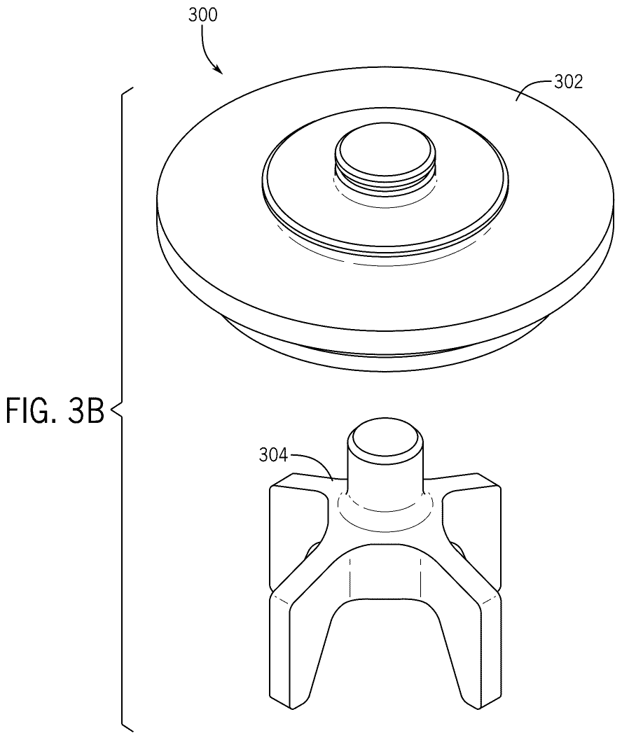

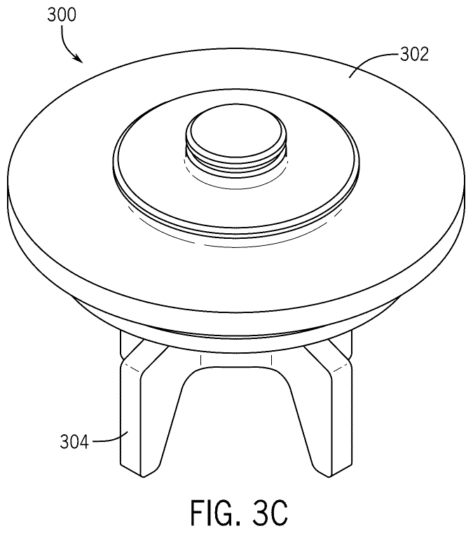

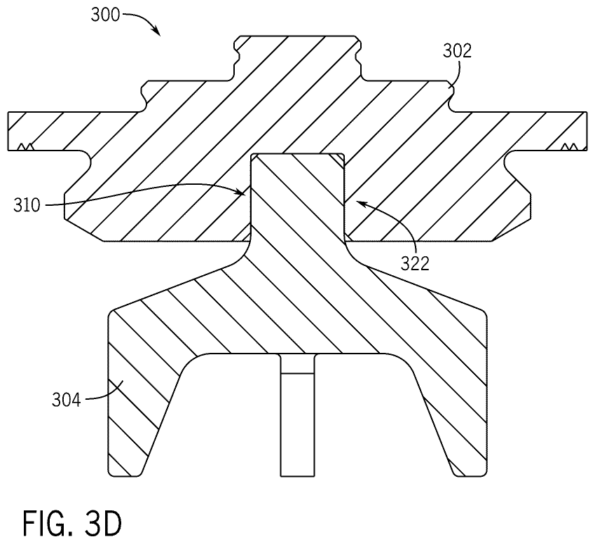

FIGS. 3A-3D illustrate a valve member 300 that may be formed using embodiments of the systems and methods disclosed herein. FIG. 3A is a sectional exploded view of an embodiment of the valve member 300 including an upper portion 302 (e.g., top portion, body, seal carrier, etc.) and guide legs 304 (e.g., guide leg assembly, legs, lower portion, etc.). In operation, the upper portion 302 will be joined to the guide legs 304 and utilized with a valve assembly. In this example, the upper portion 302 includes an annular recess 306 for receiving and supporting a seal element (not pictured) which may be a non-metallic seal element, such as an elastomer or the like. The recess 306 includes retention features 308 that may dig into or otherwise hold the seal element in place.

Further illustrated in FIG. 3A is a cavity 310 formed within an underside 312 (e.g., bottom side) of the upper portion 302. The cavity 310 in this example extends upwardly toward a top side 314 and includes is generally cylindrical with a cavity diameter 316. It should be appreciated that a cylindrical cavity is for illustrative purposes only and that the cavity may have a variety of different shapes and configurations. Furthermore, a single cavity is also for illustrative purposes and there may be multiple different cavities formed along the underside 312. The cavity 310 is further illustrated as being substantially centered along an axis 318 of the valve member 300, but this is for illustrative purposes only and the cavity 310 may be offset from the axis 318. Furthermore, while a single cavity 310 is shown in this illustrated embodiment, various embodiments may include multiple cavities 310 that may receive coupling elements from the guide legs 304.

The guide legs 304 are illustrated decoupled from the upper portion 302, for example prior to an assembly process, such as a process that will be described herein. In various embodiments, the guide legs 304 include three legs 320, but it should be appreciated that there may be more or fewer legs 320 and three is just shown as an example. The guide legs 304 further includes a coupling member 322 that is adapted to engage the upper portion 302, for example via installation within the cavity 310. As noted above, a number of coupling members 322 may conform to a number of cavities 310 of the upper portion 302. However, there may be more or fewer coupling members 322 and/or cavities 310. For example, different configurations may be used for different guide legs 304 such that the various configurations may be unique to reduce a likelihood an unintended set of guide legs 304 is coupled to the upper portion 302. As will be described below, it should be appreciated that an opposite configuration may also be considered where the cavity 310 is formed in the guide legs 304 and the coupling member 322 is formed on the upper portion 302. In this example, the coupling member 322 is substantially cylindrical to conform to the shape of the cavity 310. In various embodiments, a coupling member diameter 324 is sized to facilitate a press fit to couple the upper portion 302 to the coupling member 322. For example, the coupling member diameter 324 may be approximately the same size as the cavity diameter 316 and/or larger than the cavity diameter 316 such that the coupling member 322 remains positioned within the cavity 310 after installation.

In operation, the guide legs 304 may be joined to the coupling member 324 via a press fitting operation. By way of example, the guide legs 304 may be secured to a fixture along with a non-metallic sealing element. Thereafter, a metal sealing element and/or non-metallic seal carrier may be installed on the top of the fixture and a linear force may be applied to drive the three components together using a single operation. However, it should be appreciated that other methods may also be utilized join the components together. As an example, the guide legs 304 may be placed within a fixture along with the metal sealing element/non-metallic seal carrier at a top of the fixture. A linear force may be used to join the components together, and thereafter, the non-metallic element may be positioned within the fixture. The assembled components may then be positioned within the fixture and another linear force may drive the non-metallic seal onto the resident seal carrying ring.

FIG. 3B is an exploded view of the upper portion 302 and the guide legs 304 and FIG. 3C is a top perspective view of the valve member 300 illustrating the upper portion 302 and the guide legs 304. FIG. 3D is a cross-sectional view illustrating the upper portion 302 joined to the guide legs 304, for example via a press fit operation. As illustrated, the coupling member 322 extends into the cavity 310 to secure the guide legs 304 to the upper portion 302. It should be appreciated that various dimensions may be particularly selected based on one or more operating conditions. For example, a planar bottom surface of the upper portion 302 may be designed to be spaced a distance from the individual legs 320, and as a result, various dimensions, such as a cavity depth or a coupling member length, may be adjusted to accommodate such a design consideration.

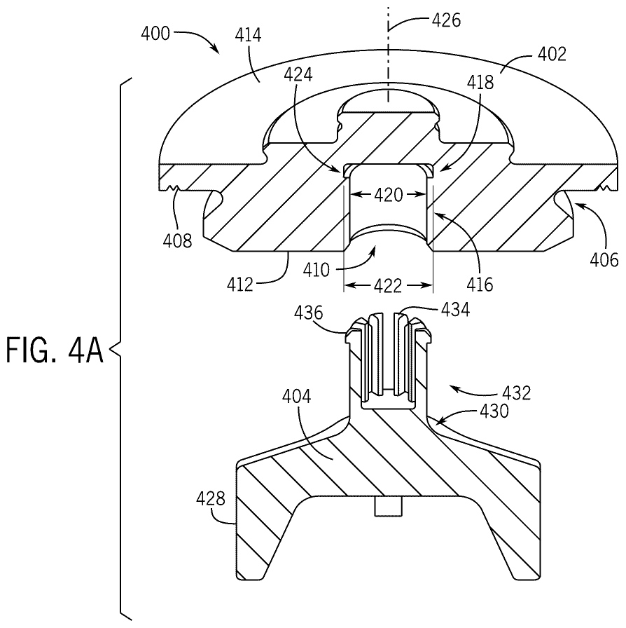

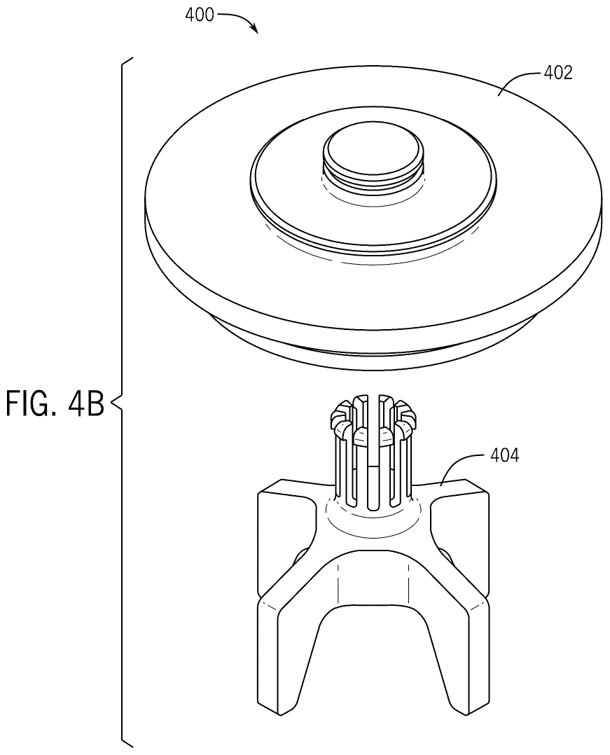

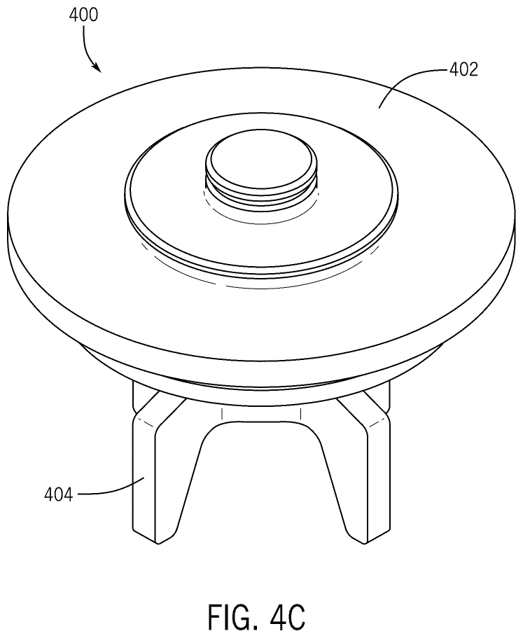

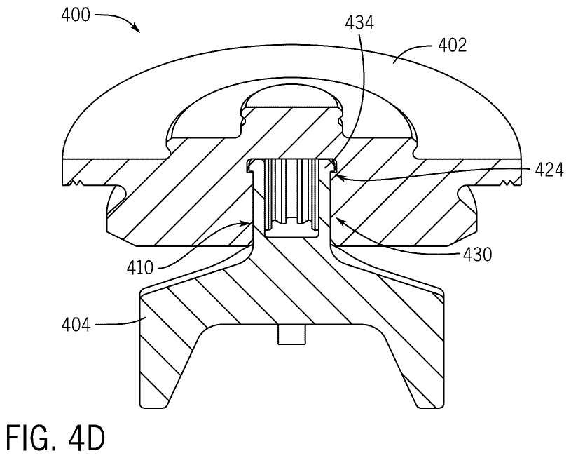

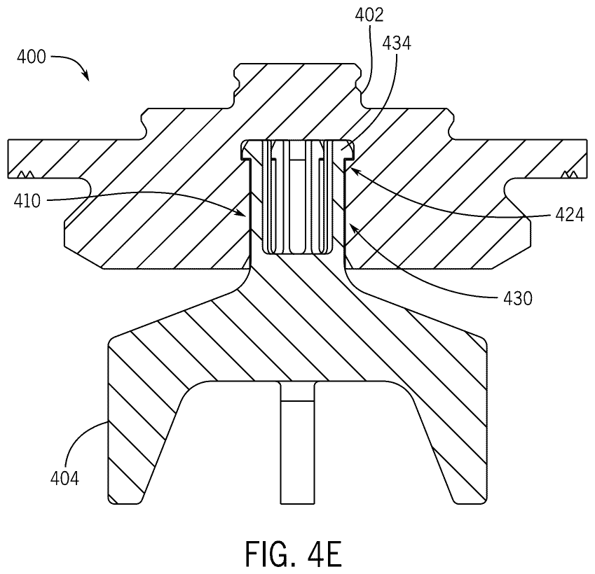

FIGS. 4A-4E illustrate a valve member 400 that may be formed using embodiments of the systems and methods disclosed herein. It should be appreciated that the valve member 400 may share one or more features with the valve member 300. FIG. 4A is a cross-sectional exploded view of an embodiment of the valve member 400 including an upper portion 402 (e.g., top portion, body, seal carrier, etc.) and guide legs 404 (e.g., guide leg assembly, legs, lower portion, etc.). In operation, the upper portion 402 will be joined to the guide legs 404 and utilized with a valve assembly. In this example, the upper portion 402 includes an annular recess 406 for receiving and supporting a seal element (not pictured) which may be a non-metallic seal element, such as an elastomer or the like. The recess 406 includes retention features 408 that may dig into or otherwise hold the seal element in place.

Further illustrated in FIG. 4A is a cavity 410 formed within an underside 412 of the upper portion 402. The cavity 410 in this example extends upwardly toward a top side 414 and includes a first portion 416 and a second portion 418. In this example, the first portion 416 has a first portion diameter 420 and the second portion 418 has a second portion diameter 422. The second portion diameter 422 is larger than the first portion diameter 420, thereby forming a shelf 424, which, as will be described below, may receive one or more components to facilitate coupling between the upper portion 402 and the guide legs 404. As shown in this example, each of the first and second portions 416, 418 are generally cylindrical and symmetrical about an axis 426, but it should be appreciated that such a configuration is for illustrative purposes only and the cavity may have a variety of different shapes and configurations. Furthermore, a single cavity is also for illustrative purposes and there may be multiple different cavities formed along the underside 414. The cavity 410 is further illustrated as being substantially centered along the axis 426 of the valve member 400, but this is for illustrative purposes only and the cavity 410 may be offset from the axis 426.

The guide legs 404 are illustrated decoupled from the upper portion 402, for example prior to an assembly process, such as a process that will be described herein. In various embodiments, the guide legs 404 include three legs 428, but it should be appreciated that there may be more or fewer legs 428 and three is just shown as an example. The guide legs 404 further includes a coupling member 430 that is adapted to engage the upper portion 402, for example via installation within the cavity 410. In this example, the coupling member 430 includes a plurality of fingers 432 (e.g., snap fingers) that may be biased to drive radially outward from the axis 426. In one or more embodiment, an inward radial force (e.g., toward the axis 426) may be applied to the fingers 432, for example via insertion of the fingers 432 into the cavity 410 to permit installation of the coupling member 430 within the cavity 410. As the coupling member 430 is driven through the cavity 410, upon interaction with the second portion 418, the fingers 432 may no longer be subjected to the inward radial force, thereby expanding outwardly to engage the larger diameter of the second portion 418. Thereafter, extensions 434 at the ends of the fingers 432 may engage the shelf 424 responsive to a downward force to separate the guide legs 404 from the upper portion 402. As noted above, a number of coupling members 430 may conform to a number of cavities 410 in various embodiments. Furthermore, there may be more or fewer coupling members 430 and/or cavities 410 which may function as identifiers or indications for installation of different types of guide legs 304.

The illustrated fingers 432 extend along the axis 426 and are positioned circumferentially about the axis 426. It should be appreciated that any number of fingers 432 may be used and that spacing between the fingers 432 may vary based on a particularly selected configuration. In this example, the extensions 434 are positioned on individual fingers 432, thereby facilitating flexing for each individual finger 432 responsive to interactions, for example interactions with a slanted region 436 along the extensions 434. It should be appreciated that an alternative configuration may also be considered where the cavity 410 is formed in the guide legs 404 and the coupling member 430 is formed on the upper portion 402. Accordingly, components such as the shelf 424 may also be positioned within the cavity 410 on the guide legs 404 and the fingers 432 may extend from the upper portion 402.

In operation, the guide legs 404 may be joined to the coupling member 424 via a press fitting or other linear force operation. By way of example, the guide legs 404 may be secured to a fixture along with a non-metallic sealing element. Thereafter, a metal sealing element and/or non-metallic seal carrier may be installed on the top of the fixture and a linear force may be applied to drive the three components together using a single operation. However, it should be appreciated that other methods may also be utilized join the components together. As an example, the guide legs 404 may be placed within a fixture along with the metal sealing element/non-metallic seal carrier at a top of the fixture. A linear force may be used to join the components together, and thereafter, the non-metallic element may be positioned within the fixture. The assembled components may then be positioned within the fixture and another linear force may drive the non-metallic seal onto the resident seal carrying ring.

FIG. 4B is an exploded view of the upper portion 402 and the guide legs 404 and FIG. 4C is a top perspective view of the valve member 400 illustrating the upper portion 402 and the guide legs 404. FIG. 4D is a sectional view and FIG. 4E is a cross-sectional view illustrating the upper portion 402 joined to the guide legs 404. As illustrated, the coupling member 430 extends into the cavity 410 to secure the guide legs 404 to the upper portion 402. For example, the extensions 434 are positioned over the shelf 424 to prevent separation of the guide legs 404 from the upper portion 402.

In various embodiments, at least a portion of the fingers 432 may be accessible after installation within the cavity 410, for example at a lower region of the coupling member 430. As a result, one or more tools may be utilized to compress or otherwise apply a radially inward force to the fingers 432, thereby facilitating removal of the guide legs 404 by driving the extensions 434 off of the shelf 424 to permit passage through the cavity 410. However, in various embodiments, the fingers 432 may be secured within the cavity 410 or otherwise shielded from external forces to reduce a likelihood of decoupling the guide legs 404 from the upper portion 402.

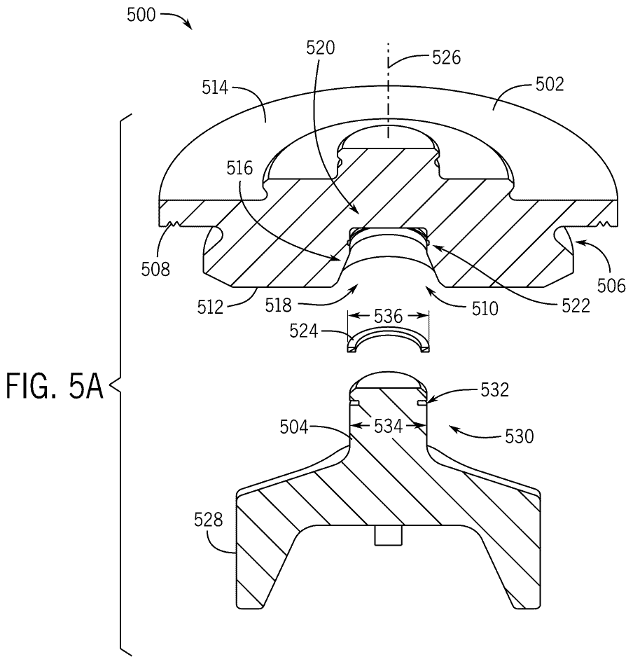

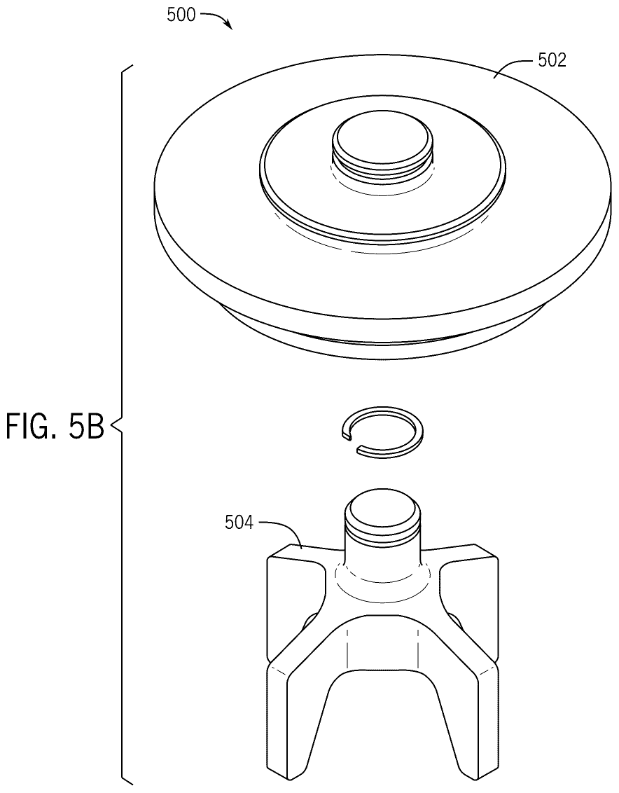

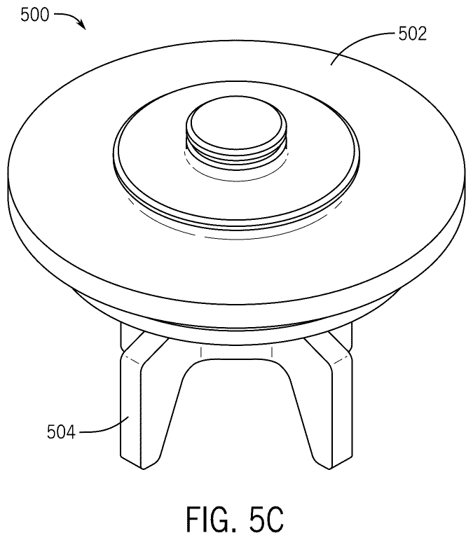

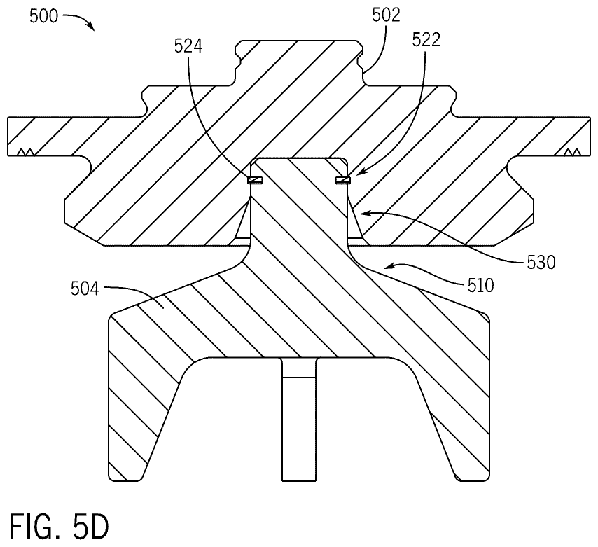

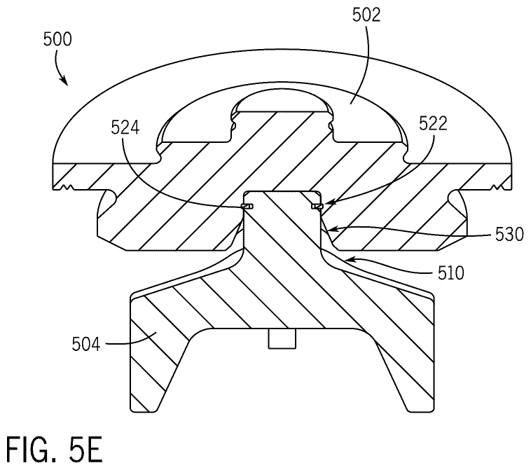

FIGS. 5A-5E illustrate a valve member 500 that may be formed using embodiments of the systems and methods disclosed herein. It should be appreciated that the valve member 500 may share one or more features with the valve members 300, 400. FIG. 5A is a sectional exploded view of an embodiment of the valve member 500 including an upper portion 502 (e.g., top portion, body, seal carrier, etc.) and guide legs 504 (e.g., guide leg assembly, legs, lower portion, etc.). In operation, the upper portion 502 will be joined to the guide legs 504 and utilized with a valve assembly. In this example, the upper portion 502 includes an annular recess 506 for receiving and supporting a seal element (not pictured) which may be a non-metallic seal element, such as an elastomer or the like. The recess 506 includes retention features 508 that may dig into or otherwise hold the seal element in place.

Further illustrated in FIG. 5A is a cavity 510 formed within an underside 512 of the upper portion 402. The cavity 510 in this example extends upwardly toward a top side 514 and includes a variable diameter 516 that is larger at a first end 518 than at a second end 520. Moreover, along the cavity 510, a groove 522 is formed, which may be utilized to receive a coupler 524, such as a snap ring, o-ring, and the like. In this example, the variable diameter 516 has a curved or arcuate profile, but it should be appreciated that this configuration is for illustrative purposes only and that in other embodiments there may be a different profile, such as a stepped profile or a sloped profile. In this example, the cavity 510 is arranged along and symmetrical about an axis 526, but it should be appreciated that such a configuration is for illustrative purposes only and the cavity may have a variety of different shapes and configurations. Furthermore, a single cavity is also for illustrative purposes and there may be multiple different cavities formed along the underside 512. The cavity 510 is further illustrated as being substantially centered along the axis 526 of the valve member 500, but this is for illustrative purposes only and the cavity 510 may be offset from the axis 526.

The guide legs 504 are illustrated decoupled from the upper portion 502, for example prior to an assembly process, such as a process that will be described herein. In various embodiments, the guide legs 504 include three legs 528, but it should be appreciated that there may be more or fewer legs 528 and three is just shown as an example. The guide legs 504 further include a coupling member 530 that is adapted to engage the upper portion 502, for example via installation within the cavity 510. In this example, the coupling member 530 includes an annular groove 532 to receive the coupler 524. As a result, upon installation of the coupler 524, a coupling member diameter 534 will be less than a coupler diameter 536, thereby facilitating engagement with the groove 522 formed in the cavity 510. For example, the coupling member 530 may be inserted into the cavity 510 until the coupler 524 engages the groove 522. In this manner, further movement of the guide legs 504 relative to the upper portion 502 may be blocked. It should be appreciated that an opposite configuration may also be considered where the cavity 510 is formed in the guide legs 504 and the coupling member 530 is formed on the upper portion 502. As an example, the groove 522 may be within the cavity 510 formed in the guide legs 504 while the coupler 542 is positioned within the groove 532 formed on the upper portion 502. Moreover in one or more embodiments, the coupler 524 may be integrally formed along the coupling member 530, for example, as an extension or the like.

In operation, the guide legs 504 may be joined to the coupling member 530 via a press fitting or other linear force operation. By way of example, the guide legs 504 may be secured to a fixture along with a non-metallic sealing element. Thereafter, a metal sealing element and/or non-metallic seal carrier may be installed on the top of the fixture and a linear force may be applied to drive the three components together using a single operation. However, it should be appreciated that other methods may also be utilized join the components together. As an example, the guide legs 504 may be placed within a fixture along with the metal sealing element/non-metallic seal carrier at a top of the fixture. A linear force may be used to join the components together, and thereafter, the non-metallic element may be positioned within the fixture. The assembled components may then be positioned within the fixture and another linear force may drive the non-metallic seal onto the resident seal carrying ring.

FIG. 5B is an exploded view of the upper portion 502 and the guide legs 504 and FIG. 5C is a top perspective view of the valve member 500 illustrating the upper portion 502 and the guide legs 504. FIGS. 5D and 5E are cross-sectional views illustrating the upper portion 502 joined to the guide legs 504. As illustrated, the coupling member 530 extends into the cavity 510 to secure the guide legs 504 to the upper portion 502. For example, the coupler 524 is aligned with the groove 522 to block further movement of the guide legs 504.

As shown in FIG. 5B, the coupler 524 may be configured as a ring with an open end such that the coupler 524 may be stretched or otherwise deformed to be positioned within the groove 522 (FIA. 5A). In at least one embodiment, one or more connectors may further be arranged along the coupler 524 to join the ends together, such as a threaded fitting. However, it should be appreciated that a force of the coupler 524 contracting against a stretched out position around the groove 522 may be sufficient to maintain a position of the coupler 524 within the groove 522.

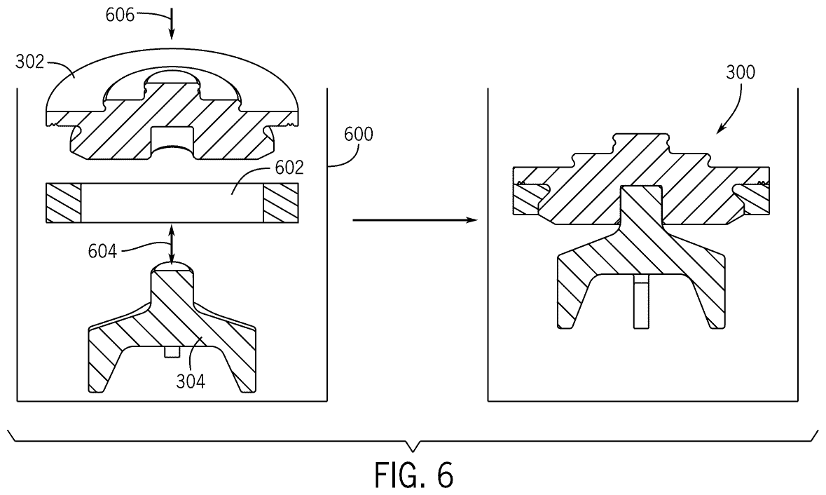

FIG. 6 is a schematic diagram of a method for assembling a valve assembly. It should be appreciated that one or more of the valve assemblies 300, 400, 500 may be assembled using this process, but numbering with respect to assembly 300 is used for simplicity. In this example, the upper portion 302 is arranged within a fixture 600 axially above a sealing element 602 and the guide legs 304. It should be appreciated that an axial distance 604 may separate one or more of the components. A force 606 is applied to generate the valve assembly 300. In various embodiments, assembly is performed with a single force application, rather than in a multi-step process. The force 606 may be considered a linear force, as the force is aligned with an axis of the valve member 300 (such as axis 318 in FIG. 3A). The force 606 in this example is shown in a downward direction (e.g., applied to the top portion 302 toward the guide legs 304), but it should be appreciated that alternative configurations may apply the force 606 to the guide legs 304 in an upward direction. Furthermore, it should be appreciated that the illustrated configuration may be flipped 180 degrees such that the top portion 304 is arranged within the fixture 600 such that the cavity 310 is pointing in an upward direction (e.g., opposite the direction of the force 606) and the guide legs 304 may be flipped 180 degrees such that the coupling member 322 is pointed in a downward direction (e.g., along the direction of the force 606) to engage the cavity 310.

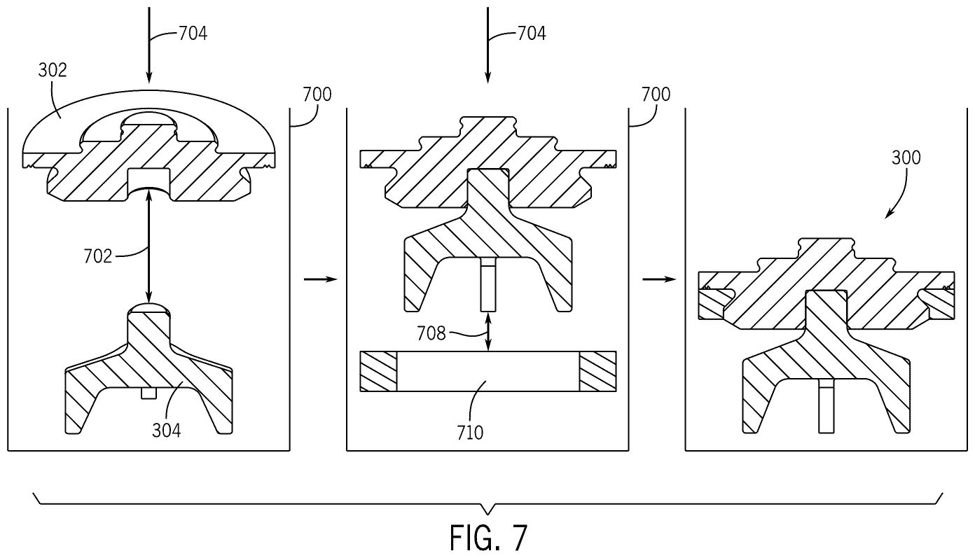

FIG. 7 is a schematic diagram of a method for assembling a valve assembly. It should be appreciated that one or more of the valve assemblies 300, 400, 500 may be assembled using this process, but numbering with respect to assembly 300 is used for simplicity. In this example, the upper portion 302 is arranged within a fixture 700 axially above the guide legs 304. It should be appreciated that an axial distance 702 may separate the components. A force 704 is applied to generate an intermediate assembly 706. As shown, the force 704 is in a downward direction (e.g., applied to the upper portion 302 to drive the upper portion 302 toward the guide legs 304), but in other embodiments, the force 704 may be an upward force that drives the guide legs 304 toward the upper portion 302. Furthermore, as noted with respect to FIG. 7, configurations may flip the components by 180 degrees such that upper portion 302 is within the fixture 700 and the guide legs 304 are driven in a downward direction via the force 704.

Continuing with the assembly, the intermediate assembly 706 is positioned an axial distance 708 from a sealing element 710. It should be appreciated that the axial distance 708 may be greater than, less than, or equal to the axial distance 702. Thereafter, the force 704 is applied to form the valve assembly 300. In various embodiments, assembly is performed with two force applications, where the magnitude of the force applications may be different for different parts of the assembly process. Moreover, it should be appreciated that the relative positions of the components may be changed in different embodiments.

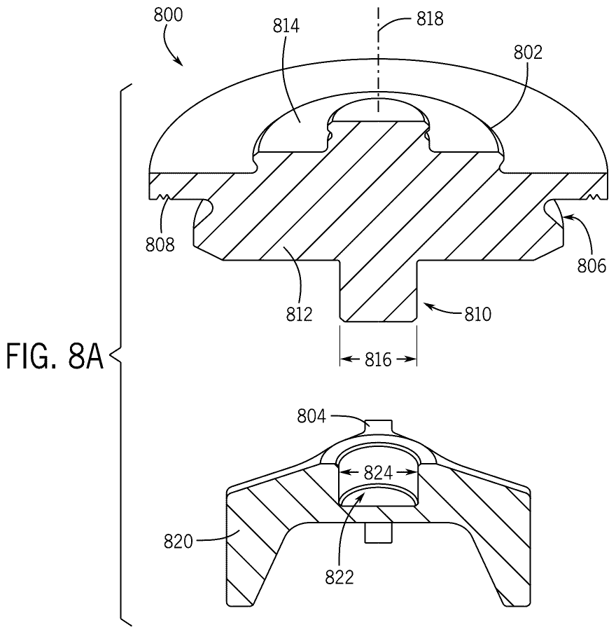

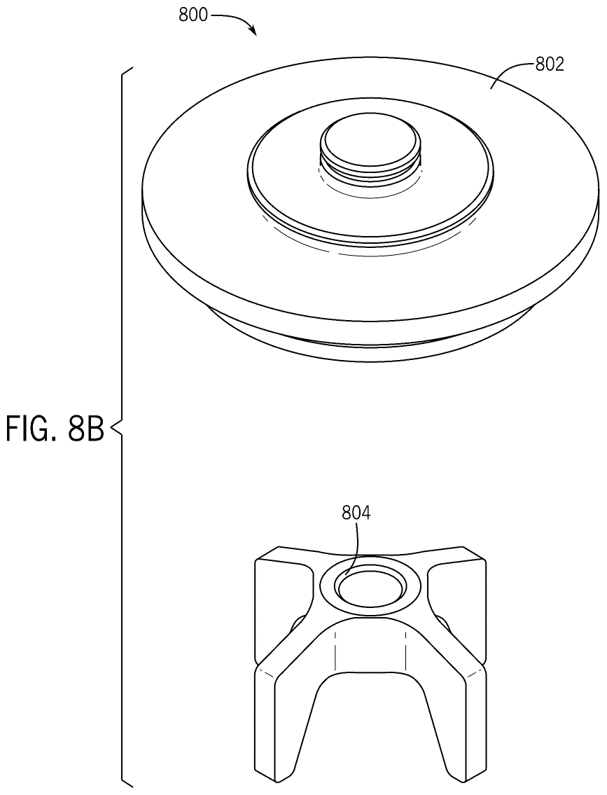

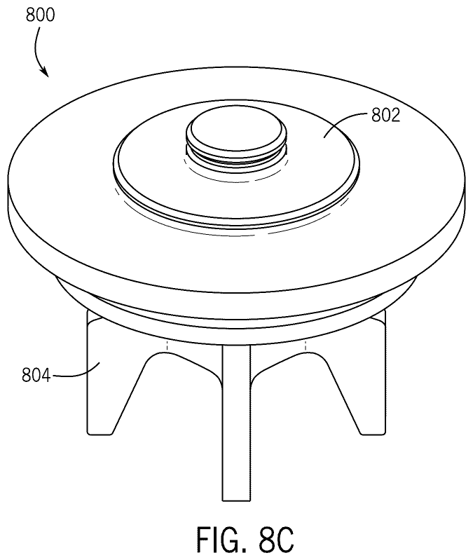

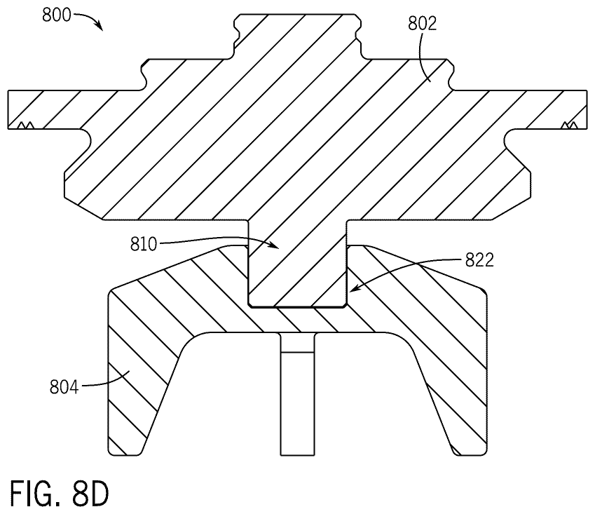

FIGS. 8A-8D illustrate a valve member 800 that may be formed using embodiments of the systems and methods disclosed herein. It should be appreciated that the valve member 800 may share one or more features with the valve members 300, 400, 500 described herein. FIG. 8A is a sectional exploded view of an embodiment of the valve member 800 including an upper portion 802 (e.g., top portion, body, seal carrier, etc.) and guide legs 804 (e.g., guide leg assembly, legs, lower portion, etc.). In operation, the upper portion 802 will be joined to the guide legs 804 and utilized with a valve assembly. In this example, the upper portion 802 includes an annular recess 806 for receiving and supporting a seal element (not pictured) which may be a non-metallic seal element, such as an elastomer or the like. The recess 806 includes retention features 808 that may dig into or otherwise hold the seal element in place.

Further illustrated in FIG. 8A is a coupling member 810 extending axially away from an underside 812 of the upper portion 402. The cavity 510 in this example extends downwardly away from a top side 814 and underside 812 and includes a substantially constant diameter 816. It should be appreciated that the diameter 816 may be variable or change at various locations based on anticipated design conditions and the constant diameter is shown for illustrative purposes only. In this example, the coupling member 810 is arranged along and symmetrical to an axis 818, but it should be appreciated that such a configuration is for illustrative purposes only and the coupling member 810 may have a variety of different shapes and configurations. Furthermore, a single coupling member 810 is also for illustrative purposes and there may be multiple different coupling members formed along the underside 812. As noted above, different configurations of coupling members 810 may be utilized for identification purposes. The coupling member 810 is further illustrated as being substantially centered along the axis 818 of the valve member 800, but this is for illustrative purposes only and the coupling member 810 may be offset from the axis 818.

The guide legs 804 are illustrated decoupled from the upper portion 802, for example prior to an assembly process, such as a process described herein. In various embodiments, the guide legs 804 include three legs 820, but it should be appreciated that there may be more or fewer legs 820 and three is just shown as an example. The guide legs 804 further includes a cavity 822 that is adapted to engage the upper portion 802, for example via installation of the coupling member 810. In this example, the cavity 822 includes cavity diameter 824 that is substantially equal to the coupling member cavity 816, which may enable a press or interference fit to join the components together.

In operation, the guide legs 804 may be joined to the upper portion 802 via a press fitting or other linear force operation. By way of example, the guide legs 804 may be secured to a fixture along with a non-metallic sealing element. Thereafter, a metal sealing element and/or non-metallic seal carrier may be installed on the top of the fixture and a linear force may be applied to drive the three components together using a single operation. However, it should be appreciated that other methods may also be utilized join the components together. As an example, the guide legs 804 may be placed within a fixture along with the metal sealing element/non-metallic seal carrier at a top of the fixture. A linear force may be used to join the components together, and thereafter, the non-metallic element may be positioned within the fixture. The assembled components may then be positioned within the fixture and another linear force may drive the non-metallic seal onto the resident seal carrying ring.

FIG. 8B is an exploded view of the upper portion 802 and the guide legs 804 and FIG. 8C is a top perspective view of the valve member 800 illustrating the upper portion 802 and the guide legs 804. FIG. 4D is a cross-sectional view illustrating the upper portion 802 joined to the guide legs 804. As illustrated, the coupling member 810 extends into the cavity 822 to secure the guide legs 804 to the upper portion 802.

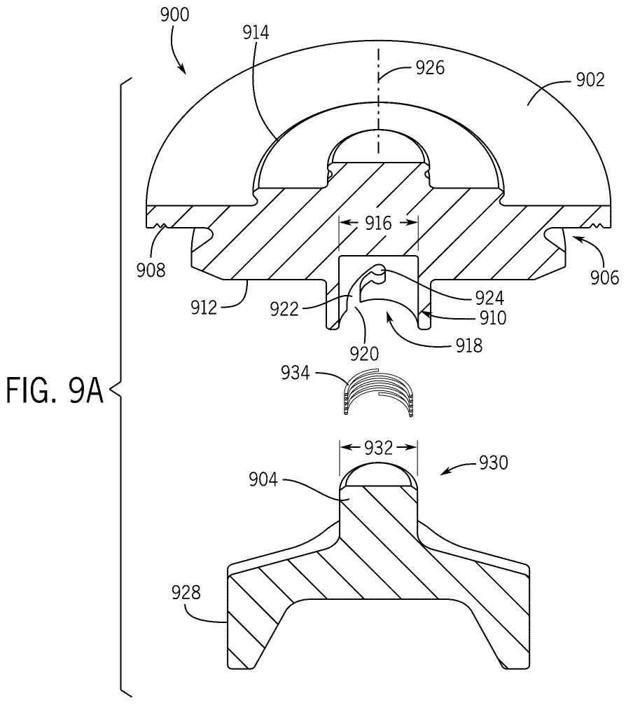

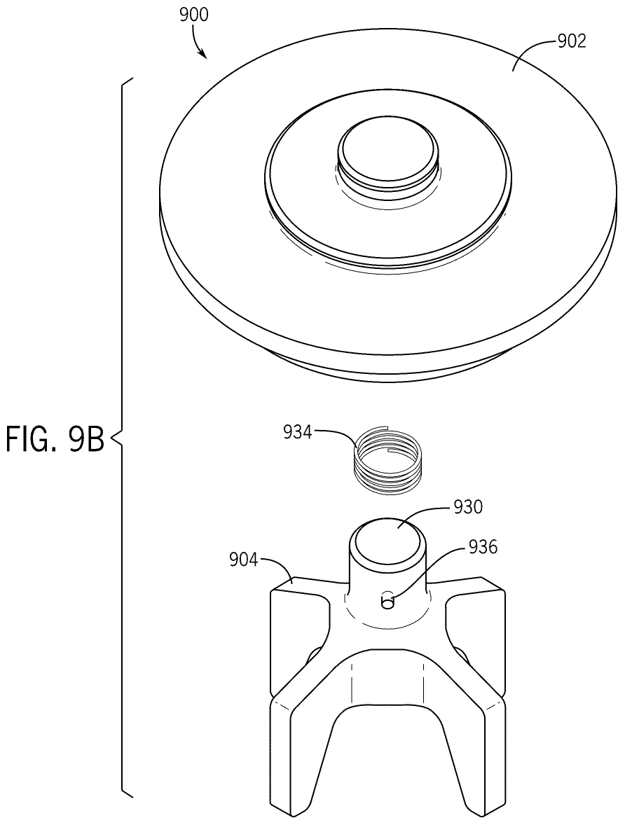

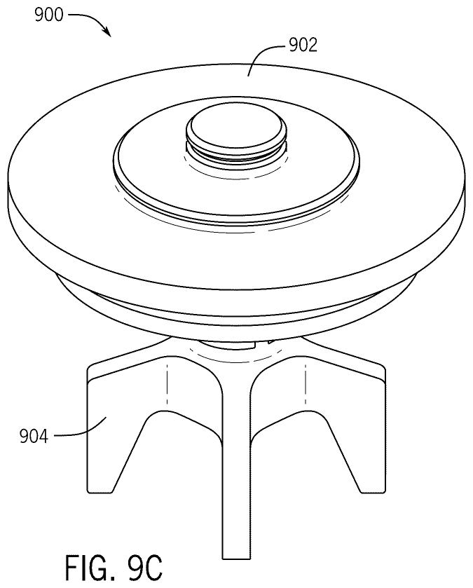

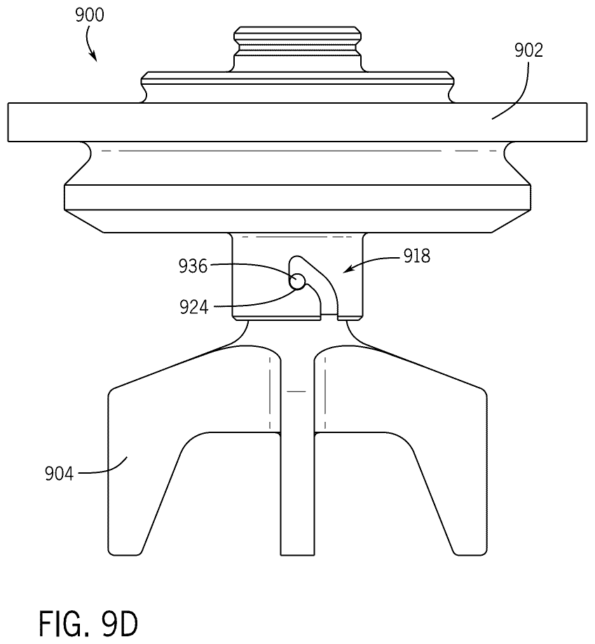

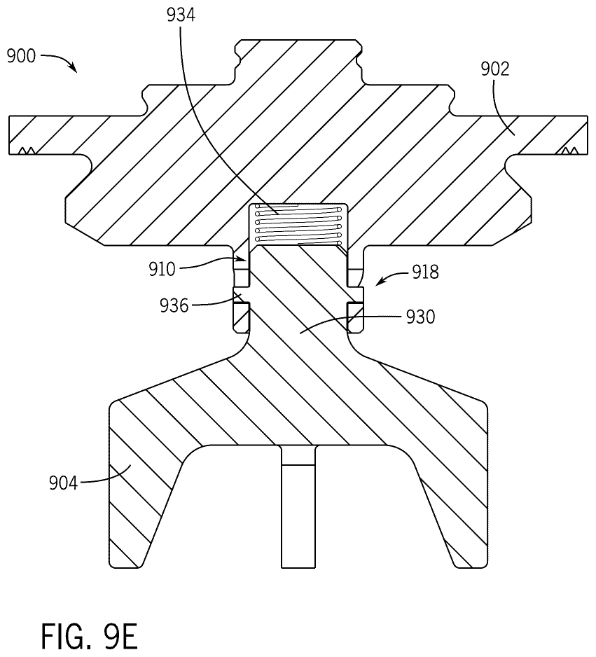

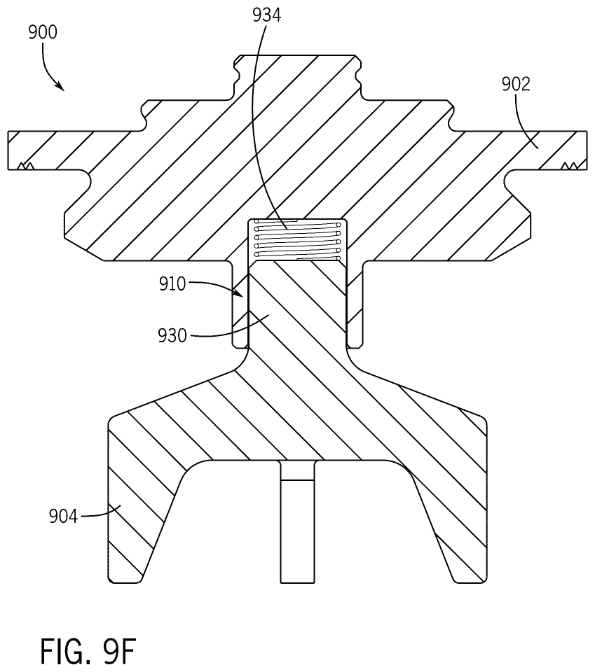

FIGS. 9A-9F illustrate a valve member 900 that may be formed using embodiments of the systems and methods disclosed herein. It should be appreciated that the valve member 900 may share one or more features with the valve members 300, 400, 500, 800. FIG. 9A is a cross-sectional exploded view of an embodiment of the valve member 900 including an upper portion 902 (e.g., top portion, body, seal carrier, etc.) and guide legs 904 (e.g., guide leg assembly, legs, lower portion, etc.). In operation, the upper portion 902 will be joined to the guide legs 904 and utilized with a valve assembly. In this example, the upper portion 902 includes an annular recess 906 for receiving and supporting a seal element (not pictured) which may be a non-metallic seal element, such as an elastomer or the like. The recess 906 includes retention features 908 that may dig into or otherwise hold the seal element in place.

Further illustrated in FIG. 9A is a cavity 910 formed within an underside 912 of the upper portion 902. The cavity 910 in this example extends upwardly toward a top side 914 and includes a constant cavity diameter 916, but it should be appreciated that the diameter may be a variable diameter in other embodiments, as described herein. However, various portions of the cavity 910 includes a cutout 918 that may be utilized with a bayonet style connection between the upper portion 902 and the guide legs 904. In this example, the cutout 918 includes an entry 920, a curved portion 922, and a receptacle 924, but these components are shown for illustration only. By way of example, the curved portion 922 may be different shapes, such as a stepped portion or a portion that is fully revolved around the cavity 910, among other options. For example, in one or more embodiments, the cutout 918 may be considered a J-slot type of connection, but as noted above, various configurations may be utilized that fall within the scope of the present disclosure. As will be described, a peg or extension from the guide legs 904 may be inserted through the entry 920, rotated along the curved portion 922, and then positioned within the receptacle 924 to secure the guide legs 904 to the upper portion 902.

In this example, the cavity 910 is arranged along an axis 926, but it should be appreciated that such a configuration is for illustrative purposes only and the cavity may have a variety of different shapes and configurations. Furthermore, a single cavity 910 is also for illustrative purposes and there may be multiple different cavities formed along the underside 912. The cavity 910 is further illustrated as being substantially centered along the axis 926 of the valve member 900, but this is for illustrative purposes only and the cavity 910 may be offset from the axis 926. Moreover, as noted above with respect to other configurations, the cavity 910 may also be formed within the guide legs 904 to provide an opposing configuration to the one shown in FIG. 9A.

The guide legs 904 are illustrated decoupled from the upper portion 902, for example prior to an assembly process, such as a process that will be described herein. In various embodiments, the guide legs 904 include three legs 928, but it should be appreciated that there may be more or fewer legs 928 and three is just shown as an example. The guide legs 904 further includes a coupling member 930 that is adapted to engage the upper portion 902, for example via installation within the cavity 910. In this example, a pin or extension associated with the coupling member 930 is not visible, but will be illustrated in subsequent views. In this example, a coupling member diameter 932 is substantially equal to the cavity diameter 916, but for the extension (not pictured). Further illustrated in FIG. 9A is a resilient member 934, such as a spring, that will be positioned between at least a portion of the cavity 910 and the coupling member 930. In operation, the resilient member 934 will drive the extension (not pictured) against the receptacle to block separation of the guide legs 904 from the upper portion. It should be appreciated that an opposite configuration may also be considered where the cavity 910 is formed in the guide legs 504 and the coupling member 930 is formed on the upper portion 902.

In operation, the guide legs 904 may be joined to the coupling member 930 via a press fitting or other linear force operation. By way of example, the guide legs 904 may be secured to a fixture along with a non-metallic sealing element. Thereafter, a metal sealing element and/or non-metallic seal carrier may be installed on the top of the fixture and a linear force may be applied to drive the three components together using a single operation. Moreover, a twisting operation may also be applied to facilitate movement of the extension (not pictured) along the curved portion 922. However, it should be appreciated that the linear force may be sufficient to drive the extension (not pictured) along the curved portion 922. Moreover, it should be appreciated that other methods may also be utilized join the components together. As an example, the guide legs 904 may be placed within a fixture along with the metal sealing element/non-metallic seal carrier at a top of the fixture. A linear force may be used to join the components together, and thereafter, the non-metallic element may be positioned within the fixture. The assembled components may then be positioned within the fixture and another linear force may drive the non-metallic seal onto the resident seal carrying ring.

FIG. 9B is an exploded view of the upper portion 902 and the guide legs 904 and FIG. 9C is a top perspective view of the valve member 900 illustrating the upper portion 902 and the guide legs 904. As shown, in FIG. 9B an extension 936 is illustrated extending radially away from the coupling member 930. In operation, the extension 936 is positioned within the entry 920 and moved along the curved portion 922 to engage the receptacle 924, thereby securing the guide legs 904 to the lower portion 902. It should be appreciated that one or more extensions 936 may be utilized in various embodiments. Furthermore, while a cylindrical extension is shown, other embodiments may include different shapes.

FIG. 9D is a side view illustrating the valve member 900 in which the upper portion 902 is joined to the guide legs 904 such that the extension 936 engages the receptacle 924. In this example, the resilient member 934 (not pictured) drives the guide legs 904 in a downward direction, which applies a force to the extension 936 against the receptacle 924. Accordingly, rotation of the guide legs 904 relative to the upper portion 902 is blocked, securing the guide legs 904 to the upper portion 902. As noted above, various embodiments may include one or more connections, for example, multiple extensions 936 within multiple cutouts 918.

FIGS. 9E and 9F are cross-sectional views illustrating the upper portion 902 joined to the guide legs 904. As illustrated, the coupling member 930 extends into the cavity 910 to secure the guide legs 904 to the upper portion 902 via engagement between the extensions 936 and the cutouts 918. In this example, there are two cutouts 918 and two extensions 936, but it should be appreciated that there may be more or fewer in various embodiments. Moreover, as noted above, the extensions 936 may be formed on the upper portion 902 while the cutouts 918 are formed on the guide legs 904 Upon being connected, the illustrated resilient member 934 applies a downward force to the guide legs 904 to drive the extension 936 against the upper portion 902, thereby securing the guide legs 904 to the upper portion 902.

It should be appreciated that one or more components described herein may be formed from a metallic material. Furthermore, one or more components may be formed from a non-metallic material. By way of example only, the upper portion 302 may be a metallic material while the guide legs 304 may be a metal, plastic, composite, or combination thereof.

This application is a continuation of U.S. Non-Provisional application Ser. No. 17/678,136, filed Feb. 23, 2022, titled “SYSTEM AND METHOD FOR VALVE ASSEMBLY,” now U.S. Pat. No. 12,292,120, issued May 6, 2025, which claims the benefit of U.S. Provisional Patent Application No. 63/152,501, filed Feb. 23, 2021, titled “SYSTEM AND METHOD FOR VALVE ASSEMBLY,” the full disclosures of which are hereby incorporated herein in their entireties by reference.

The foregoing disclosure and description of the disclosed embodiments is illustrative and explanatory of the embodiments of the disclosure. Various changes in the details of the illustrated embodiments can be made within the scope of the appended claims without departing from the true spirit of the disclosure. The embodiments of the present disclosure should only be limited by the following claims and their legal equivalents.

1. A valve member comprising:
(a) an upper portion having a body, a top side, a recess, and a cavity extending at least partially into the body, the cavity including:
a first portion having a first diameter, and
a second portion axially spaced by at least the first portion and having a second diameter greater than the first diameter;
(b) one or more guide legs comprising:
one or more legs, and
a coupling member extending axially from the one or more legs, the coupling member comprising a plurality of fingers extending from the one or more legs to flex radially inward responsive to a force driving the plurality of fingers within the first portion; and
(c) a sealing element positioned within the recess so that the upper portion connects to both the one or more guide legs and the sealing element, thereby to position the sealing element within the recess and to position the coupling member into the cavity.

2. The valve member of claim 1, wherein:
the plurality of fingers extend axially away from the one or more legs, and
the coupling member further comprises an extension of each finger of the plurality of fingers, each extension positioned radially outward with respect to a respective finger, and so that the plurality of fingers expand radially outward to position respective extensions on the shoulder when the respective extensions are aligned with the second portion.

3. The valve member of claim 1, wherein the cavity and the coupling member are joined via an interference fit.

4. The valve member of claim 1, wherein the cavity further comprises a shoulder located at a transition between the first portion and the second portion, and
wherein at least a portion of the coupling member engages the shoulder when the coupling member is positioned within the cavity.

5. A valve member comprising:
(a) an upper portion comprising:
a top side,
an underside,
a recess positioned between the top side and the underside, and
a cavity extending at least partially into a body of the upper portion, the cavity arranged at the underside and having:
a first portion adjacent the underside, the first portion having a first diameter, and
a second portion axially spaced from the underside by at least the first portion and having a second diameter greater than the first diameter;
(b) one or more guide legs comprising:
one or more legs, and
a coupling member extending from the one or more legs, the coupling member comprising a plurality of fingers extending from the one or more legs to flex radially inward responsive to force, thereby to drive the plurality of fingers within the first portion; and
(c) a sealing element configured to be positioned within the recess so that the upper portion connects to the one or more guide legs or the sealing element when force is applied thereto.

6. The valve member of claim 5, wherein:
the cavity comprises a cavity shoulder at a transition between the first portion and the second portion,
the plurality of fingers extend away from the one or more legs and are biased in an outward direction,
the coupling member further comprises an extension located on each finger of the plurality of fingers, each extension having a greater extension radius and a respective finger radius, and so that the plurality of fingers expand radially outward to position respective extensions on the cavity shoulder when the respective extensions are aligned with the second portion.

7. The valve member of claim 5, wherein the cavity and the coupling member are joined via an interference fit.

8. A method for forming a valve member, the method comprising:
positioning one or more guide legs for connection to a carrier portion, the guide legs including a plurality of fingers extending therefrom;
positioning, axially spaced from the one or more guide legs, a sealing element;
positioning, axially spaced from the sealing element, the carrier portion; and
applying force, thereby to flex the plurality of fingers radially inward, thereby to drive the guide legs, the sealing element, and the carrier portion into a mating relationship.

9. The method of claim 8, wherein the applying of the linear force results in the one or more guide legs connected to the carrier portion before the sealing element is connected to the carrier portion.

10. The method of claim 8, wherein the applying of the force results in an interference fit between the guide legs and the carrier portion.

11. The method of claim 8, wherein:
the carrier portion includes a cavity and the one or more guide legs includes a coupling member comprising the plurality of fingers, and
the applying of the force results in the coupling member and the cavity engaging one another.

12. The method of claim 8, wherein the sealing element is positioned axially opposite the carrier portion relative to the one or more guide legs.

13. The method of claim 8, wherein the sealing element is positioned between the one or more guide legs and the carrier portion.

14. The method of claim 8, wherein the force comprises a downward direction applied to the carrier portion.

15. The method of claim 8, wherein the force comprises an upward direction applied to the guide legs.

16. A valve assembly comprising:
an upper portion to be connected to one or more guide legs, a cavity within one of the upper portion or the one or more guide legs, and a coupling member associated with the other of the upper portion or the one or more guide legs, the coupling member comprising a plurality of fingers to flex inward responsive to force driving the plurality of fingers, so that the upper portion couples to the one or more guide legs when force is applied thereto.

17. The valve assembly of claim 16, wherein:
the cavity has a first portion adjacent an opening of the cavity, the first portion having a first diameter, and a second portion axially spaced from the opening of the cavity by at least the first portion and having a second diameter greater than the first diameter,
the cavity comprises a cavity shoulder at a transition between the first portion and the second portion,
the plurality of fingers extend axially away from the guide legs and are biased in a radially outward direction, and
the coupling member further comprises an extension located on each finger of the plurality of fingers, each extension having a greater extension radius and a respective finger radius, so that the plurality of fingers expand radially outward to position respective extensions on the cavity shoulder when the respective extensions are aligned with the second portion.

18. The valve assembly of claim 16, wherein the cavity and the coupling member are jointed via an interference fit.
